(19) United States
(12) Patent Application Publication
(10) Pub. No.: US 2003/0004766 A1
(43) Pub. Date: Jan. 2, 2003

(54) Method for implementing a best practice idea

(75) Inventors: Chris Sandoval, Farmington Hills, MI (US); Charles A. Selke, Farmington Hills, MI (US); Charles H. Watson, West Bloomfield, MI (US); Frederick P. Ellert, Milan, MI (US); Jeffry Grupp, Whitmore Lake, MI (US); Kalyan Dutta, Ann Arbor, MI (US); Kathryn Howe-Vandelinder, Ann Arbor, MI (US); Saundra Elnora Lamb, Farmington Hills, MI (US); Terrence Berndt, Farmington Hills, MI (US); Vish Daita, Farmington Hills, MI (US)

Correspondence Address: BROOKS & KUSHMAN P.C./FGTI, 1000 TOWN CENTER, 22ND FLOOR, SOUTHFIELD, MI, 48075, US

(73) Assignee: Ford Motor Company, Dearborn, MI (US)

(21) Appl. No.: 10/063,124

(22) Filed: Mar. 22, 2002

Related U.S. Application Data
(60) Provisional application No. 60/277,925, filed on Mar. 22, 2001.

(51) Int. Cl. G06F 17/60

(52) U.S. Cl. 705/7

(57) ABSTRACT

A best practice idea is received from a requester. The best practice idea is assigned to an ownership team and a functional champion within the organization. The process ownership team and the functional champion analyze the best practice idea to confirm that the best practice idea is a best practice, assess the feasibility of the best practice, and are responsible for the development and implementation of the best practice idea. The best practice idea is presented to an executive sponsor for approval and commitment. The executive sponsor possesses the executive authority to exercise organizational resources necessary to develop and implement the best practice idea. A project plan is developed for the best practice idea to track any necessary steps for developing and implementing the best practice idea. The best practice idea is developed according to the project plan and deployed within at least one organizational function.

### CROSS REFERENCE TO RELATED APPLICATIONS

This application claims the benefit of U.S. provisional application Serial No. 60/277,925, filed Mar. 22, 2001.

### BACKGROUND OF INVENTION

1. Field of the Invention

The present invention relates generally to the implementation of best practice processes or ideas within one or more functional units across an organization.

2. Background Art

A best practice process is the result of adapting efficient tools and methods to the environment, culture and needs of an organization. Traditional best practice processes involve surveys and benchmarking to identify best practice processes among all existing processes or potential alternatives. Best practices are widespread in industry and are sought after for making productivity gains and boosting the bottom line.

Generally, consultants or non-profit organizations identify and document practices in industry, government or academia; sharing the information with participants and/or subscribers. From the pattern of practices uncovered by the survey, the surveyor is able to identify best practices. These findings are published in survey reports, distributed electronically and/or in hard copy and may be presented at organizational or independent seminars. If the report is the result of a benchmarking exercise, participants may exchange actual data at their discretion. However, these reports do not explain how the benchmarked practice can be used in a specific organization nor under which circumstances it will work.

Prior best practices methodologies do not provide specific directions for organization or execution. They generally make recommendations about “lessons learned” which the organization attempting to initiate a best practice program needs to understand and adapt.

Accordingly, while there is much material devoted to identifying best practices in a broad industry, government or academic group, there is very little devoted to the tailoring of those best practices to the specific needs of an individual organization, i.e., deployment, implementation and institutionalization.

### SUMMARY OF INVENTION

One advantage provided by this invention is a specific set of tools and templates to maximize the benefit that results from identification and implementation of internal and external best practices. The present invention is especially suitable for larger organizations conducting multiple similar projects concurrently.

Advantageous tools provided in accordance with the present invention include implementation flowcharts, templates for useful documents role and responsibility descriptions, template tracking to allow determination of progress without excessive measurement, idea generation tools and techniques, templates for obtaining support and resources for implementing new best practices, and recommended team members.

In addition to the above advantages, the present invention provides a dynamic adaptive process. Best practice processes in accordance with the present invention are more “adaptive”. Developers and subject matter experts are typically involved in the best practice implementation process from the beginning through deployment and institutionalization. This advantage ensures that best practice can be dynamically tailored to the user community's need.

In addition, the present invention utilizes an efficient combination of human resources and information technology to achieve success.

To meet these objects, features and advantages, as well as other objects, features and advantages, preferred and alternate methods for implementing a best practice idea are provided that include receiving at least one best practice idea from one or more best practice requesters, and assigning the best practice idea to a best practice process ownership team and at least one functional champion within the organization wherein the process ownership team and the at least one functional champion analyze the best practice idea to confirm that the best practice idea is a best practice, assess the feasibility of the best practice, and are responsible for the development and implementation of the best practice idea.

The method(s) additionally include presenting the best practice idea to at least one executive sponsor for approval and commitment wherein the at least one executive sponsor possesses the executive authority to exercise organizational resources necessary to develop and implement the best practice idea, defining a project plan for the best practice idea wherein the project plan tracks any necessary steps for developing and implementing the best practice idea, developing the best practice idea according to the project plan, and deploying the best practice idea within at least one organizational function.

The best practice process ownership team and the functional champion may additionally assess the novelty and priority of the best practice idea with respect to previously identified best practice areas. The organizational resources may include human resources, machine resources, computing resources, material resources and supplier resources. The step of deploying the best practice idea may include communicating the best practice idea to organizational resources required to carry out the best practice idea and requiring that the best practice idea be carried out. The method(s) may additionally include the step of presenting the best practice idea to the process ownership team for approval prior to deployment of the best practice idea. The method(s) may additionally include implementing and institutionalizing the best practice idea within the organization. The method may additionally include conducting a pilot of the best practice idea.

The process ownership team may comprise a steering team, a roundtable group and a best practice team. The steering team may include one or more process ownership team champions and/or one or more process ownership team leaders. The one or more process ownership team champions may be responsible for managing the process ownership team and may chair the steering team. The steering team may include one or more cross-functional representatives. The steering team may allocate organizational resources for the development of the best practice idea, provide approval to begin developing the best practice idea, and approve the developed best practice idea before it is implemented. The best practice team may include one or more subject matter experts, the best practice requester, one or more user and deployment representatives, and/or one or more financial analysts. Worksheet templates may be utilized to document the identification, selection, development, and deployment of the best practice idea.

The worksheet templates may be electronic and may be populated in an online fashion. Information gathered while identifying, selecting, developing and/or deploying the at least one best practice idea may be maintained in a computer database. The computer database may be accessible and searchable via the Internet including the World-Wide-Web.

### BRIEF DESCRIPTION OF DRAWINGS

FIG. 1 is a block flow diagram illustrating a preferred methodology for implementing the present invention;

FIGS. 2a, 2b, and 2c illustrate an example best practice project worksheet in accordance with a preferred embodiment of the present invention;

FIG. 3 illustrates a preferred embodiment of a prioritization matrix in accordance with the present invention;

FIG. 4 illustrates a preferred embodiment of a POT project tracker in accordance with the present invention;

FIG. 5 illustrates a preferred embodiment of the best practice one-page summary (i.e., “BP 1-Pager”) in accordance with the present invention;

FIG. 6 illustrates a preferred embodiment of a project plan in accordance with the present invention; and

FIG. 7 illustrates a preferred embodiment of a Harvey ball chart in accordance with the present invention.

### DETAILED DESCRIPTION

A “best practice” in accordance with the present invention is the most effective way to execute a specific business process, task or objective. Best practices range from very specific practices that affect only certain individuals to general practices that impact an entire organization. A best practice may result from lessons learned, may be based on a complete process that is already being used within a company, can be a composite of elements collected from different programs or organizations, or can be an entirely new process.

Best practices enable a company to stay competitive by minimizing non-value-added work, process time and manufacturing/development costs while maximizing efficiency. Developing and implementing best practices throughout development and production reduces variability and provides cross-company alignment. Through consistency in processes, overall efficiency and product quality will improve.

In accordance with a preferred embodiment of the present invention, process ownership teams (POTs) identify best practices and plan their deployment and implementation. More particularly, POTs can comprise a steering team, a roundtable group and a best practice team. Members of the POT steering team may include a POT champion, POT leader, roundtable leaders and others (e.g., engineers, financial analysts, cross-POT representation, etc.).

The POT steering team allocates resources for the development of best practices, provides approval to begin work on a best practice idea, and approves a best practice before it is implemented. Specifically, the POT steering team ensures that all roundtables and best practice teams are adequately staffed and rewarded for their efforts, provides strategic direction, regularly reviews progress of roundtables and best practice teams, resolves issues (POT and cross-POT), ensures that recommendations are not optimizing one area at the expense of others, and shares information across roundtables and process-specific information across POTs. The POT champion develops overall POT direction, chairs the POT steering team, communicates vision, provides leadership for the development and implementation of best practices, and meets product development productivity objectives for his/her POT. The POT leader assists the POT champion with all of his/her best practice responsibilities.

Roundtables are responsible for achieving continuous improvement of major sub-processes in order to support POT overall objectives. Roundtables develop and manage specific best practices, identify and prioritize ideas for best practices, recruit best practice teams, and review and approve best practice ideas. A roundtable leader establishes and leads regular roundtable meetings, assigns resources for best practice efforts, reports progress to the steering team, and resolves problems or barriers to development, deployment or implementation. Notably, the roundtable may take on some or all of the responsibilities of the POT or the steering team.

Members of the best practice team include: subject matter experts, the best practice requester, representatives from users and deployment, and a financial analyst. The best practice team is responsible for leading the development of a best practice from the initial best practice kickoff meeting through institutionalization, supporting the implementation phase, and revising the best practice as needed.

The best practice team leader guides the team in the development and deployment of the best practice, serves as the primary contact for resolving issues that arise during the implementation phase, revises the best practice when required, reports progress to the roundtable, the best practice sponsor(s) and the POT steering team, and meets with the sponsor, steering team and functional champions for final approval of the best practice. Notably, the team leader could be the requester who originally brought the idea forward. The financial analyst helps the best practice team to quantify benefits. The requester is the person who presents an idea for a best practice. Additionally, the requester meets with the sponsor, steering team and functional champions for initial approval of the best practice idea. The subject matter expert provides relevant experience and knowledge to the best practice team and end user during development deployment and implementation. Preferably, the subject matter experts are selected on the basis of capability, availability, experience and expertise, rather than seniority or level. When possible, a team should include subject matter experts from many different organizations in order to help gain early buy-in for implementation.

Preferably, administrative and facilitative support of best practice development and deployment are provided by members of the POT support team including a best practice supervisor, roundtable process leader(s), best practice facilitator, and training and communication specialists. The process ownership support team (POST) administers, facilitates and tracks the development and implementation of best practices according to the best practice process. The POST analyzes, evaluates, selects and prioritizes best practice ideas, and provides administrative support to the steering team and roundtables. The POST assists in preparing the best practice documentation, using the mandatory formats. The POST is responsible for coaching all others involved in the best practice process, conducting briefing sessions and delivering executive presentations.

The best practice supervisor puts best practice documentation on the Web, ensures that the best practice process is followed, assesses and reports progress and status to the POT champion, conducts “program profiling” (benchmarking) to help generate best practice ideas, conducts periodic review of the best practices, reconciles differences between consumer business group deployment metrics and serves as liaison to resolve issue(s).

The roundtable process leader educates best practice teams on the best practice methodology, supports (facilitates) best practice teams to develop, deploy and institutionalize best practices, supports functional champions, functional managers, etc., to implement best practices and sets up and facilitates POT-related meetings. The best practice facilitator/training and communication specialist assesses best practice-related education, training and communication needs, and develops training and communication materials.

A sponsor is the person with the authority to ensure the implementation of a specific best practice. A sponsor agrees to support a best practice, approves an idea for development, and approves the new process. A sponsor also resolves potential issues, provides needed resources, and removes barriers to best practice development and implementation. Notably, the sponsor could be a functional champion, engineering director, etc.

The engineering director chairs the functional champions meeting for his/her product organization and serves as chairman of the POT champion's meeting. The functional champion represents the best practices of one POT within his/her organization. Additionally, a functional champion provides approval to proceed with development and deployment of a best practice, assigns the functional champion assistant, identifies programs and timing for implementation of a best practice, requests program representatives from the chief program engineers or functional engineering managers of each affected program, directs and supports the program representatives to ensure the implementation of best practices within his/her responsible functional organization, and tracks and reports best practice implementation status. Preferably, a functional champion assistant assists the functional champion with all of his/her best practice roles and responsibilities.

Table 1 contains a summary of the best practice process in accord with a preferred embodiment of the present invention. Generally, the present invention is divided into six principal phases. A more detailed description of each Phase is included in separate sections (and subsections) below.

TABLE 1

| | | |
|---|---|---|
| Phase 1 - Initiate | 1.1. | Initiate Request |
| Best practice Idea | | |
| Phase 2 - Analyze | 2.1. | Prepare Project Worksheet |
| and Select Best | 2.2. | Determine Project priority |
| practice Idea | 2.3. | Obtain Sponsor commitment |
| | 2.4. | Obtain POT Steering Team / Functional |
| | | Champion Approval to Proceed |
| Phase 3 - Develop | 3.1. | Conduct Best practice kickoff meeting |
| Best practice | 3.2. | Develop and document Best practice process |
| Phase 4 - | 4.1. | Obtain approvals |
| Approve | | |
| Best practice | | |
| Phase 5 - | 5.1. | Complete Work Items and Update |
| Deploy Best | | Documentation |
| practice | 5.2. | Conduct Pilot, if necessary |
| | 5.3. | Select and Brief Key Players |
| | 5.4. | Complete Steps for Implementation Readiness |
| Phase 6 - | 6.1. | Add Best practice to Implementation Level |
| Implement and | | Status Report (Harvey Ball Chart) |
| Institutionalize | 6.2. | Implement According to Plan and Report |
| Best practice | | Status (Ongoing) |
| | 6.3. | Periodically Review Best practices |

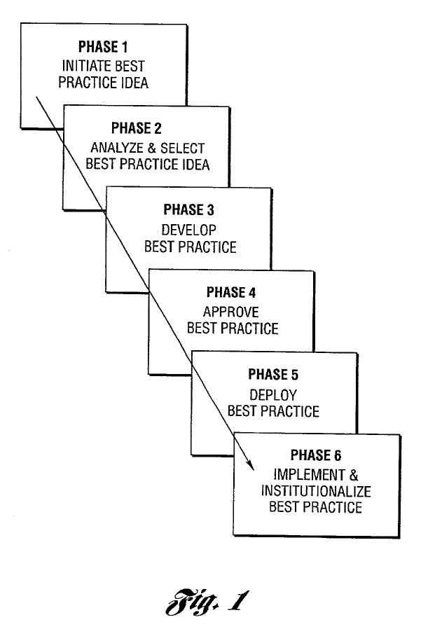

FIG. 1 is a block flow diagram illustrating a preferred methodology for implementing the present invention. Notably, the particular arrangement of phases, phase elements and implementation may be adjusted or adapted within the scope of the present invention to best suit a particular application.

Phase 1 begins the best practice process. The best practice idea is submitted, received and documented.

In Phase 2, the best practice idea is analyzed to ensure that it is not a duplicate, prioritized to see whether it should be pursued at this time, presented to sponsor(s) for their commitment to the project and their approval to proceed, and approved by the POT steering team and deployment champions for development as a best practice.

Phase 3 marks the transition of a best practice idea to a best practice project. The best practice is developed and documented.

In Phase 4, the best practice is approved by the sponsor, POT steering team and deployment champions as it shifts from development to deployment.

In Phase 5, the leader responsibility transfers from the best practice team leader to deployment leaders. All open issues are closed out and necessary steps completed in preparation for implementation of the best practice.

In Phase 6, the best practice is incorporated in existing programs, and preparation is made to ensure that it is implemented in future programs. The best practice is followed up in regular reviews.

Phase 1

Initiate Best Practice Idea

Phase 1 begins the best practices process. At this phase, the best practice idea is submitted, received, documented, and added to a POT project tracker. The POT project tracker is a listing of submitted best practice ideas and best practices by POT. It provides an “at-a-glance” status of all best practice ideas and best practices for a POT.

A “best practice idea” may be a new idea, a significant enhancement to an existing process or best practice or a replication of an existing process. Ideas may originate from:

Process problems, issues, or proposed process improvements;

Management targets for improvement; or

A compilation of lessons learned.

In accord with a preferred embodiment of the present invention, the project worksheet includes a three-part template.

The first part of the project worksheet template entitled “Best Practice Idea Submission Sheet” receives data including, but not limited to: the name of the idea (the best practice title), the name of the person submitting the idea (the requester), the requester's telephone number, the requester's corporate identification number, the date the idea was submitted, a description of the idea, and the rationale for the proposed process change (i.e., why the existing process needs changing or should be replicated).

The second part of the project worksheet entitled “Project Definition Sheet” receives data including, but not limited to: the POT number and name, the roundtable name, the search date for best practice duplication, the results of the search for any best practice duplications, the project goal (i.e., the end result of implementing the best practice), the baseline (i.e., the current process including flowcharts if necessary), a description of the work completed to date, an assessment of the benefit of the proposed best practice (i.e., cost, quality, applied time, cycle time, etc.), an assessment of the resource impact the best practice will have, an assessment of project difficulty, an assessment of sponsor support, and a history of activities affected.

The third part of the project worksheet entitled “Team Member Sheet” receives data including, but not limited to: management support (i.e., contact information for the sponsor(s) and roundtable leader(s)) and the best practice team (i.e., contact information for the best practice team leader, team members and the POT support team).

1.1. Initiate Request

A project worksheet serves as an initial communication tool between the person who introduces a new idea (requester) and a POT representative (POT support team and/or roundtable) that best-aligns with the idea.

Phase 2

Analyze and Select Best Practice Idea

In this Phase, the best practice idea is analyzed to ensure that it is not a duplicate of a previous best practice, prioritized to see whether it should be pursued at this time, presented to sponsor(s) for their commitment to the project and their approval to proceed, and approved by the POT steering team and functional champions for development as a best practice. Preferably, the POT support team is active during this Phase.

A prioritization matrix is used during this Phase to establish a best practice idea's priority. It helps to combine information collected from the requester, POT support team, and other knowledgeable individuals. The prioritization Matrix will:

Ensure that critical factors (sponsor support, net benefits, and project difficulty) in best practice development and implementation have been considered;

Allow POT support team members to vote with their individual assessment of the idea;

Provide a discussion tool for the POT support team by looking at differences in individual priority rankings;

Provide an automatic weighting of the key criteria for assessing an idea/project; and

Give the team a method of ranking projects within the POT.

2.1 Prepare Project Worksheet

The purpose of the project worksheet is to generate an initial communication tool between the person who introduces a new idea (requester) and the POT representative (POT support team and/or roundtable) that best aligns with the idea. Additionally, the project worksheet gives structure to the initial meeting or conversation between the requester and POT representative(s), helps ensure that the requester's idea fits the definition of a best practice or process improvement, and captures the information needed to determine whether to proceed with the idea. Notably, if it is determined that an idea really belongs with another POT, the project worksheet allows the transfer of information in a concise and consistent manner.

Input to this process step includes a completed idea submission sheet from the project worksheet. One task associated with this process step involves conducting a search for duplicate or similar process initiatives already in progress. If the topic has already been addressed, informative feedback is provided to the requester. If the topic has not been addressed, the online project worksheet is completed. If more information is needed, POT representatives that have worked on duplicate or similar projects are consulted for guidance. Preferably, any duplicate or similar ideas that have previously been submitted are added to the online project worksheet. Provided the topic has not been addressed, a POT representative meets with the requester to complete the project worksheet.

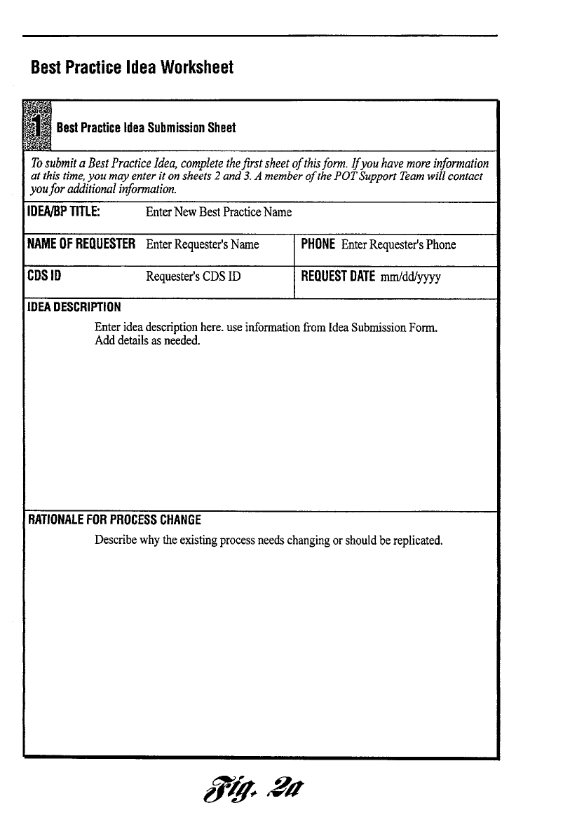

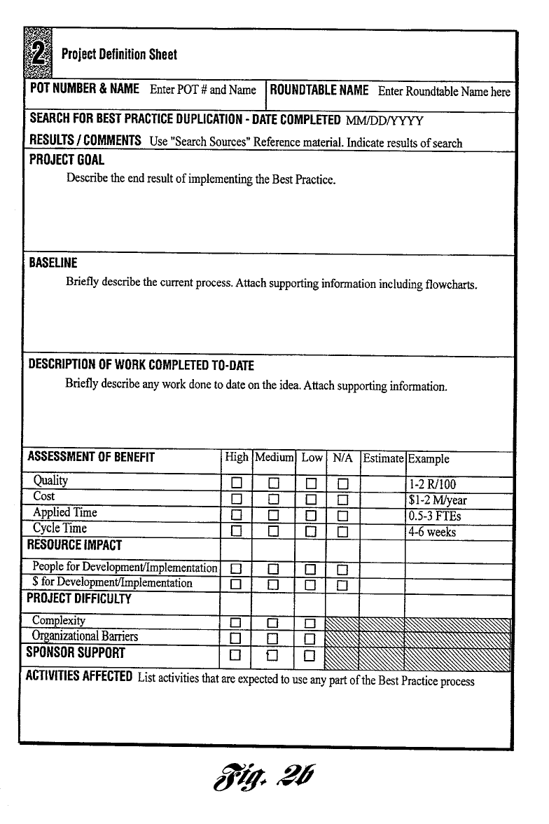

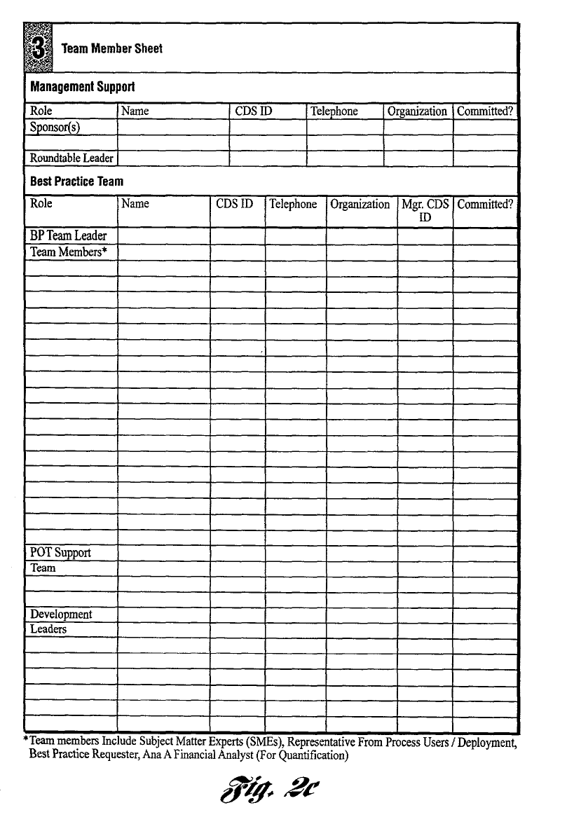

FIGS. 2a, 2b and 2c illustrate an example best practice project worksheet in accordance with a preferred embodiment of the present invention. Notably, this worksheet (and others associated with the definition and deployment of a best practice) may be implemented in an online format (i.e., Internet or web-based format).

2.2. Determine Project Priority

The purpose of this process step is to make a decision whether or not to proceed with the best practice. This decision is based on its prioritization matrix ranking against other projects in the current workload.

Inputs to this process step include the POT project tracker, the project worksheet and information on POT support team current workload.

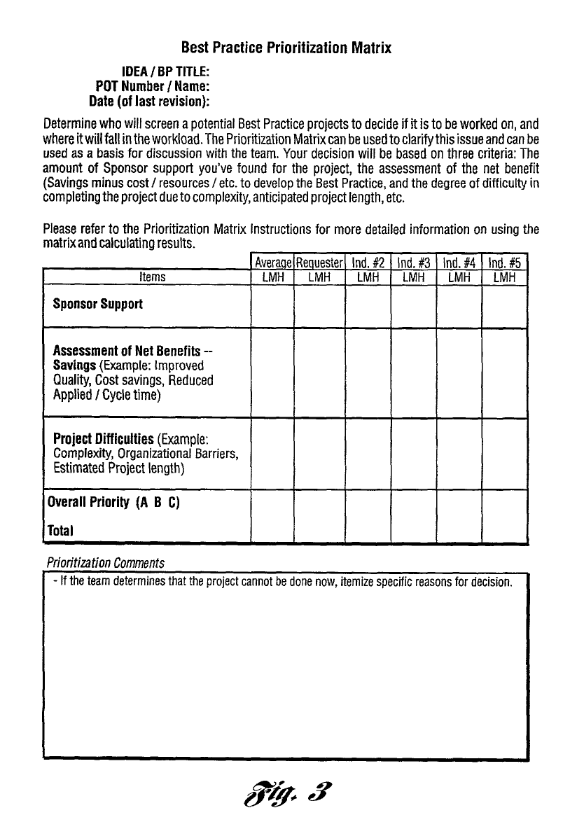

One task associated with this process step involves preparing and drafting a prioritization matrix based on currently available information. FIG. 3 illustrates a preferred embodiment of a prioritization matrix in accordance with the present invention. This matrix may be implemented in an online format.

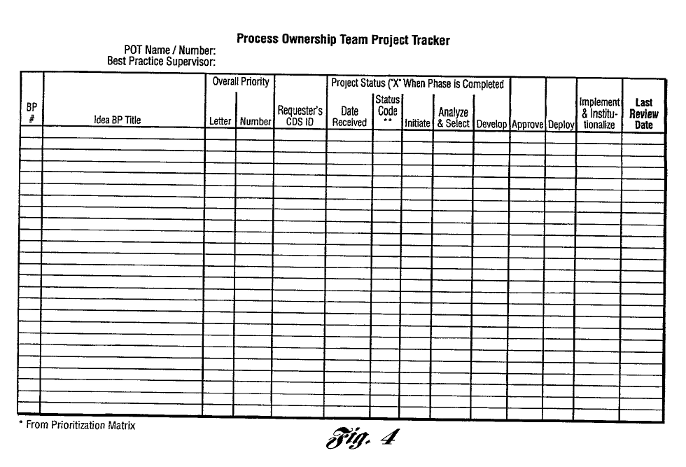

Next, an overall priority number and letter associated with the best practice are transferred to a POT project tracker. FIG. 4 illustrates a preferred embodiment of a POT project tracker in accordance with the present invention. The POT project tracker may be implemented in an online format.

Additionally, the list of best practices on the POT project tracker are sorted by priority. Finally, a decision is made whether or not to proceed with the new best practice project, based on the prioritization matrix ranking against other projects. Additionally, the status of the best practice project is indicated on the project tracker. If the decision is not to proceed, feedback is preferably provided to the requester.

2.3. Obtain Sponsor Commitment

The purpose of this process step is to obtain essential sponsorship early in the best practice process, and to update associated documentation as necessary with sponsor input. The first aspect of this process step involves meeting with sponsors to present a proposed best practice project. At the meeting, the POT representative requests sponsorship, inquires as to whether additional or different sponsors are necessary, and asks for suggestions for additional best practice team members.

The next aspect of this process step involves revising associated documents, as necessary. For example, the prioritization matrix is updated based on any new information from the sponsor meetings. Additionally, the POT project tracker is updated with new priority numbers and letters if they have changed.

Another aspect of this process step involves making a decision on whether or not to proceed, based on sponsor commitment. If a decision is made not to proceed, feedback is preferably provided to the Requester.

2.4. Present to POT Steering Team and Functional Champions

This process step verifies that the proposed project fits the scope, workload and priorities of the POT, and meets the needs of the deployment community. Additionally, qualified best practice ideas under development are added to an online database of best practices to avoid duplications.

One aspect of this process step involves meeting with the POT steering team and functional champions. Inputs to this meeting include the online POT project worksheet, a POT steering team/functional champions meeting agenda, and a support/participation letter. At the meeting, the following events preferably occur: the project worksheet is presented; agreement to proceed with the project is requested; suggestions for additional team members are requested; signatures on support/participation letters are obtained; and known functional champions are asked to identify additional functional champions. At this stage of the process step, the POT steering team can delegate approval of projects to the roundtables.

Another aspect of this process step involves completing post-meeting tasks. Post-meeting tasks include but are not limited to: revising the project worksheet with any changes or modifications suggested from the functional champions or POT steering team; sending support/participation letters or e-mail notes to potential team members and their managers; creating a preliminary best practice one-page summary (“BP 1-Pager”) and adding it to the online best practice database in “draft” status; finalizing the best practice team based on responses to support/participation letters or e-mail notes; and updating the online POT project tracker by specifying that the “Analyze/Select” Phase 1 is complete and entering the best practice number from the BP 1-Pager.

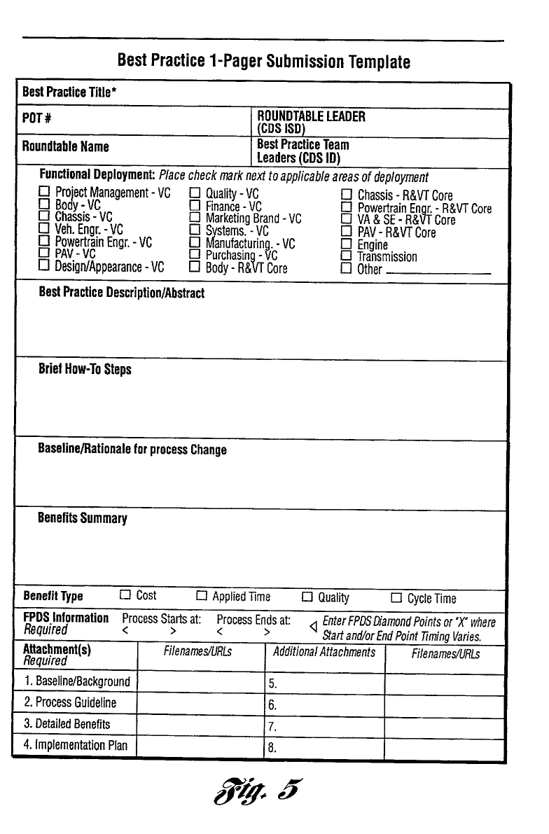

FIG. 5 illustrates a preferred embodiment of the best practice one-page summary (i.e., “BP 1-Pager”) in accordance with the present invention. The BP 1-Pager may be implemented in an online format.

Phase 3

Develop Best Practice Process Step Checklist

This Phase marks the transition of a best practice idea to a best practice project. The best practice is developed and documented during this Phase. As used in accord with the present invention, a “benefit” is the value of the best practice to the company in terms of quality, cost, applied time and cycle time. A “project plan” is a tool designed to assist the best practice team in tracking the necessary tasks for any best practice. The project plan lists all project Phases and steps from “Develop” through “Institutionalization”. The best practice team may add any best practice-specific steps to the project plan. A “Pilot” is a practical test or dry run of the best practice on a small audience that serves as a tentative model for future deployment/implementation.

3.1. Conduct Best Practice Team Kickoff Meeting

This is the first process step in best practice development. The purpose of the step is to provide the best practice team with an overview of best practice methodology and introduce them to the best practice project.

On task associated with this process step involved conducting a best practices team kickoff meeting. Activities conducted at this meeting include reviewing the project worksheet with the best practice team, determining the work method to be used, and creating the project plan. Work methods typically consist of a series of work meetings supplemented by other methods. Table 2 contains examples of common supplemental work methods including circumstances characteristic of each method.

TABLE 2

| Use this work method | When you need this . . . |
|---|---|
| RAPID | Accelerated progress on a portion of the project |
| | Assistance of a trained facilitator |
| | A structured approach |
| | Management of a large Best practice Team |
| | Development of a complex process |
| Global 8D Session | To quickly diagnose and solve a process problem |
| | Management/Facilitation of a cross-functional |
| | team |
| | A structured approach |
| Focused Improvement | Handling projects with a larger scope |
| Series of Meetings | Use this method when none of the above methods |
| | is appropriate |

More specifically, RAPID is an acronym for “Rapid Actions for Process Improvement Deployment”. RAPID is a workshop-based tool which brings teams together to focus on a specific business process. During the workshop, concerns are identified, recommendations and action plans are developed, and unfiltered feedback is provided to the RAPID sponsors. The sponsors decide immediately whether or not the recommendations should be implemented.

The Global 8D Process is a disciplined, team-oriented problem-solving process that applies analytical tools to data in order to identify the problem, define the root cause or potential root cause and verify, implement and validate actions to eliminate the problem or to actuate performance improvement and to prevent problem recurrence.

3.2. Develop and Document Best Practice Process

During this process step, the project is developed and documented according to a project plan.

One task associated with this process step involves using one of the work methods chosen in process step 3.1 to develop the best practice.

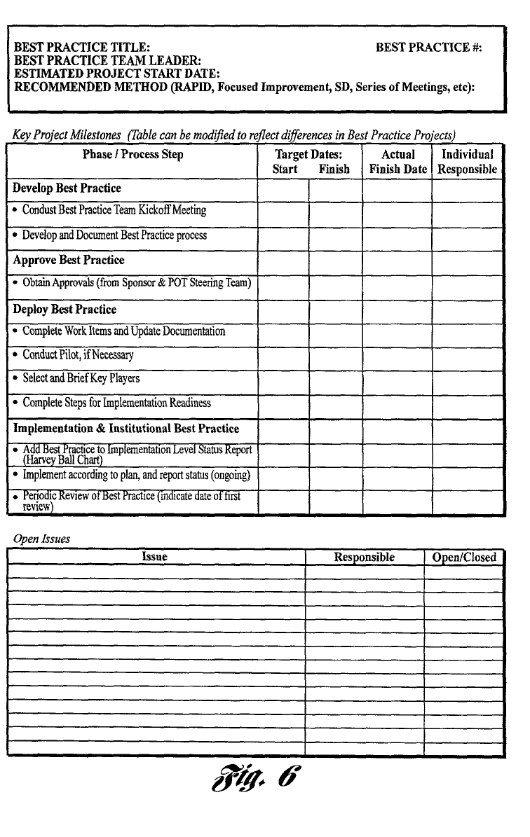

FIG. 6 illustrates a preferred embodiment of a project plan in accordance with the present invention. The project plan illustrated in FIG. 6 may be implemented in an online format.

More particularly, this task involves one or more of the following: defining the baseline and background for the best practice; developing a process guideline; completing an invention disclosure form; calculating detailed benefits of the best practice; developing an implementation plan; and determining if a pilot is needed. If a pilot is needed, this task additionally involves determining a pilot audience. Preferably, a pilot is conducted for each best practice, except when replicating or making minor modifications to an existing process.

More particularly, the baseline and background for the best practice includes historical information about the current practice—the practice that is in place prior to development of the best practice. This information serves as the basis for quantifying the benefits of the new process. This document also provides a comparison to the new process.

The implementation plan describes the best practice team's plan for rollout, a communication/training methodology, and institutionalization methods. In addition, the implementation plan includes a description of each implementation level that will be used to report ongoing implementation status of this best practice.

Other tasks associated with this process step include completing and updating best practice documentation, developing training and communication for implementing the best practice, updating the project plan, and creating an executive summary. The executive summary is a selection of information from the best practice documentation and other sources compiled in an executive format. It is presented to sponsor(s), to the POT steering team and to functional champions at the “Approve” Phase of the best practice process.

Phase 4

Approve Best Practice

The purpose of this Phase is to transition the best practice from development to deployment, as it is approved by the sponsor, POT steering team and functional champions.

4.1. Obtain Approvals

The objective of this process step is to obtain necessary approval and support to proceed with deployment of the best practice. Inputs to this process step include the best practice documentation, the project plan, and the executive summary.

One task associated with this process step involves meeting with sponsors to obtain agreements with respect to the best practice. At this meeting, the best practice is explained, the project plan is reviewed, and the sponsor's agreement to proceed with the best practice and provide the required support and/or resources is requested.

Another task associated with this process step involves meeting with the POT steering team/functional champions to obtain approval of the process. At this meeting, the best practice is explained and a set of best practice implementation level definitions (i.e., Harvey ball definitions) are reviewed.

Additionally, the POT steering team's agreement with the best practice and approval to proceed is requested. Finally, the functional champions' approval and support of the implementation plan is requested along with their agreement to: (i) identify which programs (i.e., organizational functions) will implement the best practice; and (ii) conduct a pilot of the best practice, if necessary. Notably, if a pilot is necessary an audience must be confirmed.

Yet another task associated with this process step involves updating sponsors with project status, if required.

Phase 5

Deploy Best Practice Process Step Checklist

During this Phase, lead responsibility transfers from the best practice team leader to functional champions. All open issues on the project plan are closed out and all of the necessary steps in preparation for implementation of the best practice are completed.

In accord with this Phase, to “deploy” the best practice is to complete all necessary tasks prior to implementation. These tasks include finalizing and publishing all best practice documentation, selecting and briefing the necessary persons for managing and tracking implementation (including functional champions and ongoing support with selected best practice team members), communicating the best practice to the intended user(s) (i.e., through classes, job aids, technical forms, etc.), and conducting a pilot of the process, if necessary.

5.1. Complete Work Items and Update Documentation

The purpose of this process step is to resolve open issues and update documentation so that the best practice can be implemented. Inputs to this process step include an agreement from the POT steering team and functional champions to proceed and an updated project plan.

One task associated with this process step involves completing certain open work items such as:

1. identifying subject matter experts (SMEs) who will provide ongoing support for the best practice; and

2. signing off on the best practice and adding team signatures to a best practice team member list in the best practice documentation.

Another task associated with this process step involves closing out certain open issues. For example, open issues in the project plan are closed out. If the best practice was generated by a lessons learned, the lessons learned is closed out at this time. Training and communication materials are completed, and actions to begin institutionalization of the best practice as per the implementation plan are performed.

Yet another task associated with this process step involves updating documentation associated with the best practice including the best practice documentation, online RAPID or Global 8D databases, and the best practice 1-Pager. Additionally, the POT steering team, functional champions and sponsor are updated with the best practice status, if required.

5.2. Conduct Pilot (if Necessary)

This process step involves conducting a pilot to test the best practice and associated training and communication materials. Generally, all best practices should involve a pilot except when replicating or making minor modifications to an existing process.

One task associated with this process step involves delivering training and communication materials to the pilot audience. Another task involves conducting the pilot of the best practice. Next, results of the pilot are assessed to determine whether revisions are necessary. This task additionally involves gaining approval of best practice revisions from the POT steering team and functional champions, as necessary.

Using feedback from the pilot, revisions are made to the best practice, the associated documentation and the training/communication materials. Following this task, the status of the best practice 1-Pager is changed to “Approved”.

5.3. Select and Brief Key Players

During this process step, key players in the implementation of the best practice are selected and briefed on their roles and responsibilities. An input to this process step includes a pilot, if required.

One task associated with this process step may involve meeting with the functional manager to brief the key players on their roles and responsibilities. Another task associated with this process step may involve obtaining a list of affected programs and program representatives from the functional manager.

A third task associated with this process step may involve meeting with program representatives to discuss the best practice. Useful documentation for this meeting might include a program representative kickoff meeting agenda, a best practice one-page summary, an implementation plan, and a worksheet for the deployment leader. At this meeting, program representatives may be briefed on the details of the best practice, along with their respective roles and responsibilities. Agreement to implement the best practice may be obtained at this meeting.

Preferably, each program representative defines implementation level objectives (i.e., Harvey ball objectives) for each program.

Outputs to this process step include an informed group of responsible functional managers, as well as agreements on the roles and responsibilities of all key members involved.

5.4. Complete Steps for Implementation Readiness

During this process step, the final tasks are completed to make the best practice project implementation-ready. One task associated with this process step involves beginning user training and communication in accordance with the implementation plan. Following this task, the best practice supervisor is informed that the “deploy” step is complete.

Phase 6

Implement and Institutionalize Best Practice

During this Phase, all of the tasks necessary to successfully incorporate the best practice in existing programs are completed. Additionally, regular reviews are conducted to follow up on the best practice implementation.

As used in accord with this Phase of the present invention, “implementation” is the actual use of a best practice by the affected organization. A best practice is “institutionalized” when it becomes a way of doing business at the target company.

6.1. Add Best Practice to Implementation Level Status Report

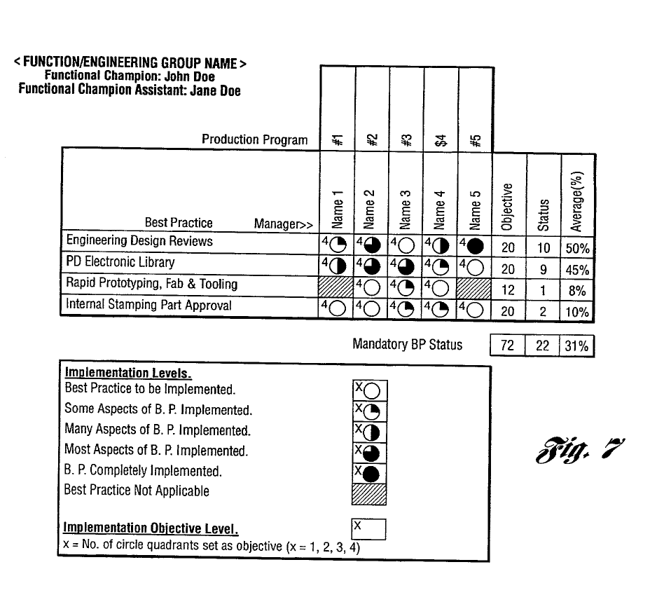

FIG. 7 illustrates a preferred embodiment of a Harvey ball chart in accordance with the present invention. The Harvey ball chart may be implemented in an online fashion. During this process step, an implementation-level status report (i.e., Harvey ball chart) is updated and reviewed for accuracy. The Harvey ball chart is a tool used to pictorially report status or progress of any project. Four quadrants of a circle are used to report the level of progress by shading the appropriate number of quadrant (s), ranging from an unshaded circle to a completely shaded circle. This tool is used in the best practice process to indicate the level of implementation of a best practice.

One task associated with this process step involves adding the best practice to the Harvey ball chart.

Another task associated with this process step involves reviewing the Harvey ball chart from each affected organization to confirm that the best practice has been added to each organization's chart. If any best practices have not been added, functional champions are involved to complete this task.

6.2. Implement According to Plan and Report Status (Ongoing)

During this process step, the best practice is implemented according to its implementation plan and the corresponding Harvey ball status is reviewed at regular intervals. One task associated with this process step involves tracking the implementation—level status (i.e., Harvey ball status) of the best practice. The status is requested from program implementers, end users and others as needed. Once collected, the implementation-level status is provided to the functional champion for review.

Another task associated with this process step involves updating the POTs Harvey ball chart and preparing a Harvey ball chart facer page listing POT overall status and major issues. This page serves as a facer or cover letter to the Harvey ball chart, when presented at the functional champions' meeting.

Yet another task associated with this process step involves reviewing the Harvey ball chart and facer page. During this task, the best practice supervisor assesses implementation-level status across line organizations, and identifies issues for discussion and resolution by the functional champions and POT steering team. Additionally, each organization's engineering director meets with all of their functional champions in regular functional champions' meetings to review status and address issues. Last, the POT steering team meets with all of its functional champions from the various organizations to review status and share implementation information across organizations, and to address issues.

It is important at this stage of the present invention to ensure that future programs implement the best practice. When each new program is added to the Harvey ball chart, process Steps 5.3-6.2 are repeated.

6.3. Periodically Review Best Practices

This process step details the regular review of all best practices and associated Harvey ball charts. An annual review is recommended in order to keep best practices current.

One task associated with the best practice review involves identifying all best practices on the POT project tracker that are implementation-ready (i.e., the “Deploy” column is checked.) Another task associated with the best practice review involves assessing the following: whether revisions to the best practice are needed, whether the best practice is institutionalized, and whether the best practice is obsolete (i.e., the best practice can no longer be used, it has been replaced or superceded, or it is no longer required). If minor revisions to the best practice are needed, they are made and republished. If major revisions are necessary, the overall best practice Process (i.e., Phases 1-6) are followed, as appropriate. If the best practice is either obsolete or institutionalized, it is archived by either changing its status on the best practice online database to “Archived” and/or adding a note to the best practice 1-Pager description. For an obsolete best practice, “Best practice archived on <date> because it has become obsolete <reason>” is added. For an institutionalized best practice, “best practice achieved on <date> because it has become institutionalized <how institutionalized>” is added.

Additionally, the corresponding functional champion is notified that the best practice is obsolete or institutionalized. Preferably, the POTs home page is also updated to reflect the current status of the best practice. Last, the status code for the best practice on the POT project tracker is changed to “Archived” and the “Last Review Date” on the POT project tracker is updated.

Another task associated with the Harvey ball chart review involves removing all obsolete and institutionalized best practices from the Harvey ball chart. Yet another task involves revising the Harvey ball chart such that all the remaining best practices are included in the organization's implementation status calculation. Any new best practices are added at this time.

While the best mode for carrying out the invention has been described in detail, those familiar with the art to which this invention relates will recognize various alternative designs and embodiments for practicing the invention as defined by the following claims.

1. A method for implementing a best practice idea within an organization comprising:
receiving at least one best practice idea from one or more best practice requesters;
assigning the best practice idea to a best practice process ownership team and at least one functional champion within the organization wherein the process ownership team and the at least one functional champion analyze the best practice idea to confirm that the best practice idea is a best practice, assess the feasibility of the best practice, and are responsible for the development and implementation of the best practice idea;
presenting the best practice idea to at least one executive sponsor for approval and commitment wherein the at least one executive sponsor possesses the executive authority to exercise organizational resources necessary to develop and implement the best practice idea;
defining a project plan for the best practice idea wherein the project plan tracks any necessary steps for developing and implementing the best practice idea;
developing the best practice idea according to the project plan; and
deploying the best practice idea within at least one organizational function.

2. The method of claim 1 wherein the best practice process ownership team and the at least one functional champion additionally assess the novelty and priority of the best practice idea with respect to previously identified best practice ideas.

3. The method of claim 1 wherein the organizational resources are selected from a group consisting of human resources, machine resources, computing resources, material resources and supplier resources.

4. The method of claim 1 wherein the step of deploying the best practice idea includes communicating the best practice idea to organizational resources necessary to effectively carry out the best practice idea and requiring that the best practice idea be carried out by those organizational resources.

5. The method of claim 1 additionally comprising presenting the best practice idea to the process ownership team for approval prior to deployment of the best practice idea.

6. The method of claim 1 additionally comprising implementing and institutionalizing the best practice idea within the at least one organizational function.

7. The method of claim 1 additionally comprising conducting a pilot of the best practice idea.

8. The method of claim 1 wherein the process ownership team comprises a steering team, a roundtable group and a best practice team.

9. The method of claim 8 wherein the steering team includes one or more process ownership team champions and one or more process ownership team leaders.

10. The method of claim 9 wherein the one or more process ownership team champions are responsible for managing the process ownership team and chair the steering team.

11. The method of claim 8 wherein the steering team includes one or more cross-functional representatives.

12. The method of claim 8 wherein the steering team allocates organizational resources for the development of the best practice idea, provides approval to begin developing the best practice idea, and approves the developed best practice idea before it is implemented.

13. The method of claim 8 wherein the best practice team includes one or more subject matter experts, the best practice requester, one or more user and deployment representatives, and one or more financial analysts.

14. The method of claim 1 wherein one or more worksheet templates are utilized to document the identification, selection, development, and deployment of the at least one best practice idea.

15. The method of claim 14 wherein the one or more worksheet templates are electronic and are populated in an online fashion.

16. The method of claim 1 wherein information gathered while identifying, selecting, developing and deploying the at least one best practice idea is maintained in a computer database.

17. The method of claim 16 wherein the computer database is accessible and searchable via the Internet including the World-Wide-Web.

18. A method for implementing best practice processes within an organization comprising:
a step for initiating at least one best practice idea;
a step for analyzing the at least one best practice idea and selecting one or more of the at least one best practice idea to implement;
a step for developing the selected best practice idea(s);
a step for approving the selected best practice idea(s); and
a step for deploying the selected best practice idea(s).

19. The method of claim 18 additionally comprising a step for implementing and institutionalizing the best practice idea.

20. The method of claim 18 additionally comprising a step for piloting the best practice idea.
